(19) United States
(12) Patent Application Publication
(10) Pub. No.: US 2013/0197162 A1
(43) Pub. Date: Aug. 1, 2013

(54) INTERCONNECTION BETWEEN CONDUCTING POLYMER MATERIALS

(71) Applicant: Massachusetts Institute of Technology, Cambridge, MA (US)

(72) Inventors: Ian W. Hunter, Lincoln, MA (US); Lauren Montemayor, San Antonio, TX (US); Eli Travis Paster, Cambridge, MA (US); Priam Pillai, Pleasant Hill, CA (US)

(73) Assignee: MASSACHUSETTS INSTITUTE OF TECHNOLOGY, Cambridge, MA (US)

(21) Appl. No.: 13/766,257

(22) Filed: Feb. 13, 2013

Related U.S. Application Data
(63) Continuation of application No. PCT/US2011/045747, filed on Jul. 28, 2011.
(60) Provisional application No. 61/373,298, filed on Aug. 13, 2010.

(51) Int. Cl. H01B 1/12

(52) U.S. Cl. CPC H01B 1/127
USPC 525/203

(57) ABSTRACT

Method for connecting two portions of a first electrically conducting polymer with a second polymer. The method includes disposing a solution of a second polymer in a solvent to be in contact with the two portions of the first electrically conducting polymer and allowing the solvent to evaporate leaving the second polymer joining the two portions of the first polymer. The second polymer may be doped to improve its conductivity.

### PRIORITY INFORMATION

The present application is a continuation of PCT Application No. PCT/US2011/045747, filed on Jul. 28, 2011 and claims priority to U.S. Provisional Application Ser. No. 61/373,298 filed on Aug. 13, 2010 both of which are incorporated herein by reference in their entireties.

### SPONSORSHIP INFORMATION

This invention was made with government support under Grant number NBCHC 0080001, awarded by the Department of the Interior. The government has certain rights in the invention.

### BACKGROUND OF THE INVENTION

This invention relates to electrically conducting polymers and more particularly to a method for joining portions of electrically conducting polymers.

Conducting polymers such as polypyrrole (PPy) have many uses resulting primarily from the fact that the polymers are flexible and can be made into thin films among other geometries. Those with skill in the art will recognize that flexible electrically conducting polymers can be used as substitutes for metal conductors. In many applications, it may be required to join two portions of a conductive polymer together and assure that the joined material is itself electrically conducting. Many interconnect techniques involve using metal solder which can add weight and impede the flexibility of the polymer material. Other techniques involve high temperatures or large electrical potentials that degrade the electrical and mechanical properties of the polymer.

An object of the invention is to provide a method that is simple and flexible method of joining conductive polymers.

### SUMMARY OF THE INVENTION

The method involves connecting two portions of an electrically conducting polymer using a second soluble polymer. It includes disposing a solution of the soluble polymer in contact with the two portions of the first electrically conducting polymer. The solvent is allowed to evaporate leaving the second polymer joining the two portions of the first polymer. In a preferred embodiment, the first electrically conducting polymer is polypyrrole (PPy). A suitable second polymer for this application is poly 3-hexyl thiophene (P3HT). A suitable solvent for the P3HT is dichloromethane which wets the surface of the PPy. In a preferred embodiment, the solution is 0.3wt % poly 3-hexyl thiophene in dichloromethane. The P3HT is doped with iodine to improve its conductivity.

### BRIEF DESCRIPTION OF THE DRAWING

FIG. 1a is a schematic illustration showing the joining of two portions of a conducting polymer connected using a soluble conducting polymer interconnect.

FIG. 1b is a schematic illustration showing the joining of two portions of conducting polymer using a soluble non-conducting polymer interconnect.

FIG. 2 is a photograph of polymer joined by the method of the invention.

FIG. 3 is a graph of a uniaxial tensile test for the joined polymer.

FIG. 4a is a picture of the joining procedure showing the unconnected conducting polymer strips

FIG. 4b is a picture of the joining procedure showing the two strips immersed into the solution

FIG. 5 is an SEM image of a fractured PPy film at the joint with P3HT.

### DESCRIPTION OF THE PREFERRED EMBODIMENT

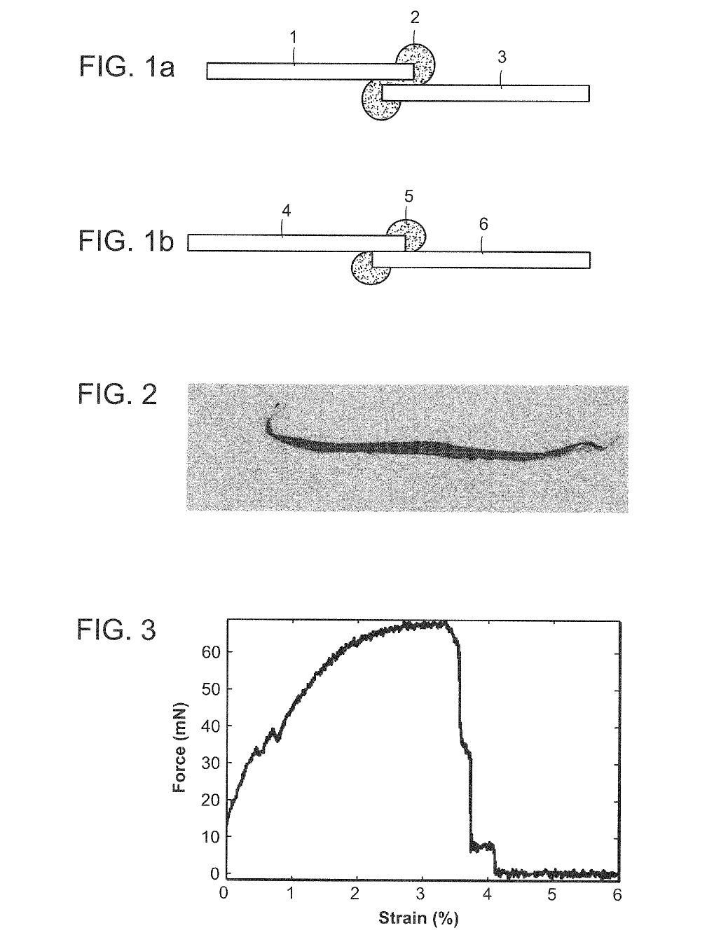

With reference first to FIG. 1a, polypyrrole portions 1 and 3 have been joined with another conducting polymer, poly 3-hexyl thiophene (P3HT). This is designated as element 2.

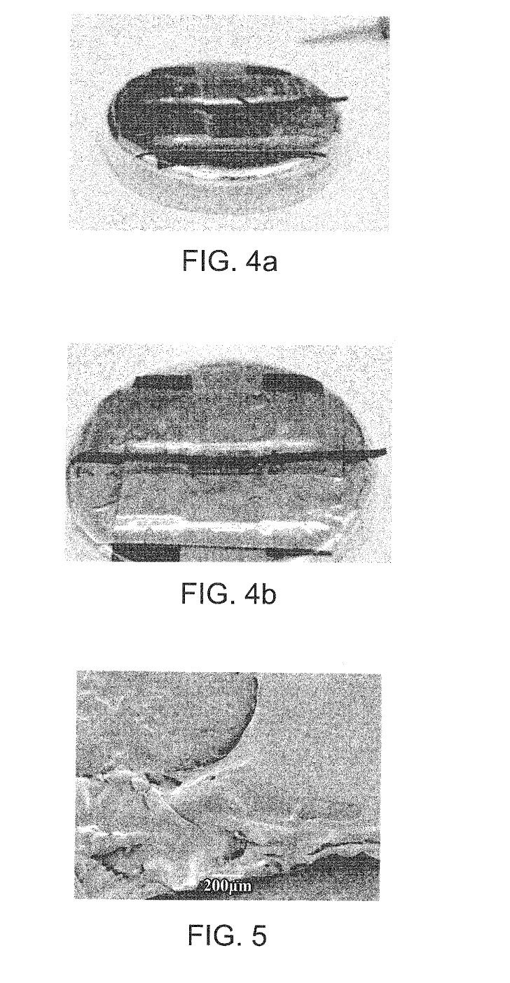

In an experiment, two thin strips of polypyrrole having dimensions 3 mm by 20 μm by 50 mm and 3 mm by 20 μm by 45 mm were fixed on the sides of a platform of a Teflon coated well. A solution of 0.3 wt % poly 3-hexyl thiophene (4.5 mg/ml) in dichloromethane (DCM) was drop cast into the well. As the DCM evaporated, a P3HT film comes out of solution in the interface between the PPy strips 1 and 3. The P3HT film creates a conducting polymer bond that joins the two strips 1 and 3 together (This procedure is illustrated in FIGS. 4a and 4b). While P3HT is electrically conducting, it is not as conducting as PPy so its conductivity can be improved by doping the P3HT film with iodine. The doping was performed by leaving iodine crystals with the joined film under a vacuum. The joined film is illustrated in the photograph of FIG. 2. FIG. 1b also shows another embodiment of the invention were a soluble non-electrically conducting polymer can be used to create the interconnect. In this embodiment a soluble polymer forms around the joint encasing the junction.

The electrical resistance of the PPy strips 1 and 3 joined with the P3HT was measured before and after the iodine doping step. The results are shown in the Table below.

TABLE

| | Pure P3HT (Ω) | I₂ Doped (Ω) |
|---|---|---|
| Left Strip | 230 | 21 |
| Right Strip | 30 | 24 |
| Total Strip | 3370 | 50 |

Stress-strain curves were measured of the joined strips and the film fractured at the P3HT joint. FIG. 3 shows the force strain curve. FIG. 5 is a scanning electron microscope micrograph showing the fracture at the joint with the P3HT. Those of ordinary skill in the art will recognize that different geometries of the conducting polymers may be used such as wires, strips or two dimensional films. Conducting polymers in all of these geometrics can be joined by the method disclosed herein. While this disclosure has focused on PPy joined with P3HT, it is to be understood that the method of the invention can be used with any conductive polymers. For example any conducting polymer including but not limited to polypyrrole, poly 3-hexyl thiophione, poly aniline, poly 3-ethylene dioxythiophnes etc can be joined using this method. Any soluble polymer including but not limited to poly 3-hexyl thiophene, polyaniline or polystyrene can also be used the interconnect material.

It is recognized that modifications and variations of the invention will be apparent to those of ordinary skill in the art and all such modifications and variations are included within the scope of the appended claims.

What is claimed is:

1. Method for connecting two portions of a first electrically conducting polymer comprising:
disposing a solution of a soluble polymer in a solvent to be in contact with the two portions of the first electrically conducting polymer; and
allowing the solvent to evaporate leaving the second polymer joining the two portions of the first polymer.

2. The method of claim 1 wherein the first polymer is polypyrrole.

3. The method of claim 2 wherein the second polymer is poly 3-hexyl thiophene.

4. The method of claim 3 wherein the solvent is dichloromethane.

5. The method of claim 3 wherein the solution is 0.3 wt % poly 3-hexyl thiophene in dichloromethane.

6. The method of claim 1 further including doping the poly 3-hexyl thiophene with iodine to improve its conductivity.
